(19) United States
(12) Patent Application Publication
(10) Pub. No.: US 2016/0272261 A1
(43) Pub. Date: Sep. 22, 2016

(54) ROBOT FOR OVER-CEILING SPACE INSPECTION

(71) Applicant: KTG Sp. z o.o., Warszawa (PL)

(72) Inventor: MARCIN GROCHOWINA, RZESZÓW (PL)

(73) Assignee: KTG Sp. z o.o., WARSZAWA (PL)

(21) Appl. No.: 14/433,975

(22) PCT Filed: Oct. 31, 2014
(86) PCT No.: PCT/PL2014/000121

§ 371 Date: Apr. 7, 2015

(30) Foreign Application Priority Data
Sep. 30, 2014 (PL) P.409658

(51) Int. Cl. B62D 57/032; B62D 57/024; B25J 15/02

(52) U.S. Cl. CPC B62D 57/032; B25J 15/0206; B62D 57/024; Y10S 901/01; Y10S 901/44; Y10S 901/47; G05B 2219/45066; G05B 2219/37206

(57) ABSTRACT

Robot for over-ceiling space inspection fitted with the enclosure with a camera inside with the preview on the operator's computer display is characterized in that it has the gripper (4) with the axis of rotation (3) of the gripper tip (1,2) and the wrist body (6) which has the gripper hinge (5) and the arm (7) connecting the bunch with the robot body. Preferably, it has not less than 6 walking legs (10), where the hind legs move autonomously repeating the movement of the front legs (10).

The components of the gripper (4) have a defined range of operation (9), the gripper in the wrist—110° and the gripper tip—270 °.

The robot has the gripper tip composed of two layers (1,2), wherein the layer (1) is made of an elastic material having a high coefficient of friction, while the layer (2) is made of a hard material having a low coefficient of friction.

The invention relates to a robot for over-ceiling space inspection, used to inspect the internal surface in case of ceilings installed by suspension, where empty spaces are formed, which are the perfect place to mount any installations without affecting the structure of the building, as well as completely closed ceiling surfaces with luminaires.

A mobile throwing robot, known from the Polish patent application P386825, intended to penetrate hard to reach areas, such as building interiors, areas covered with high baffles and the like, having an enclosure and driving mechanisms connected to it, characterized in that the enclosure has control circuit boards and batteries, and driving motors mounted to the enclosure below the control circuit boards and batteries, coupled via the drive transmission units with the wheels placed at both ends of the enclosure.

In turn, the robot for diagnosing the wear of industrial structures is known from the application P382540, in particular for monitoring loss of material in such installations as pipelines, tanks, hulls, boiler tubes, having a mobile platform fitted with a base to which at least one magnetic gripper provided with sliding magnetic grippers is attached, wherein the magnetic gripper is connected to the base by a linear drive system and the movable magnetic grippers are arranged symmetrically with respect to the gripper. The rotary drives of magnetic grippers are mounted on the extreme linear components of the driving systems, wherein the magnetic grippers are fitted with a linear driving system of vertical movement and linear driving system of transverse movement in relation to the linear movement of the driving system.

U.S. Patent US2010/0180672A1, discloses a design of the inspection robot which is characterized in that the pressure inside the robot is greater than the pressure outside, and the robot moves along the bottom of the tank by means of ultrasound sensors. The inspection method covers the ground and floating tanks (ships and vessels).

The aim of the invention is to provide a simple design of the robot to move in narrow, winding spaces in which it is impossible to move due to the objects located therein or because of its load-carrying capacity (eg. stretched ceilings).

The aim of the invention is to provide a simple design of the robot to move in narrow, winding spaces in which it is impossible to move due to the objects located therein or because of its load-carrying capacity (eg. stretched ceilings). Robot according to the invention is characterized in that it comprises a camera with a two-way communication system and is fitted with a system of gripping arms, which enable the robot to move in a way through hanging on the structural components. The gripping arms of the robot with a camera provide an interaction between the robot and its operator in a full duplex mode and enable observations of the space above the suspended ceiling. A microprocessor control system creating the image of the space around the robot in the controller's memory allows the fully automatic control of grippers invisible to the operator so as to use the same support points in the space which were used by the operator moving with the front grippers. This allows the operator to focus on the essential aspects of work, moving only two front grippers of the robot, not engaging his attention in activities that can be done outside of his perception. Particularly for the ceilings mounted by suspension the voids are formed which are the perfect place to mount any installations without affecting the structure of the building, which is an additional advantage of this technology. In the case of the use of caisson systems an easy and direct access to installations above the suspended ceiling for inspection, maintenance and possible repair is possible. However, in the case of ceilings made in the solid form, i.e. from drywall or other enabling to obtain big, monolithic surfaces an access to the space above them is difficult or impossible in certain cases without damage to the ceiling surface. The system of inspection openings or removable elements such as light fixtures provides local access only. There is no possibility of access to locations distant from the inspection openings or hidden by the objects located in the ceiling space.

The invention is shown in the exemplary embodiment in the schematic drawings in which

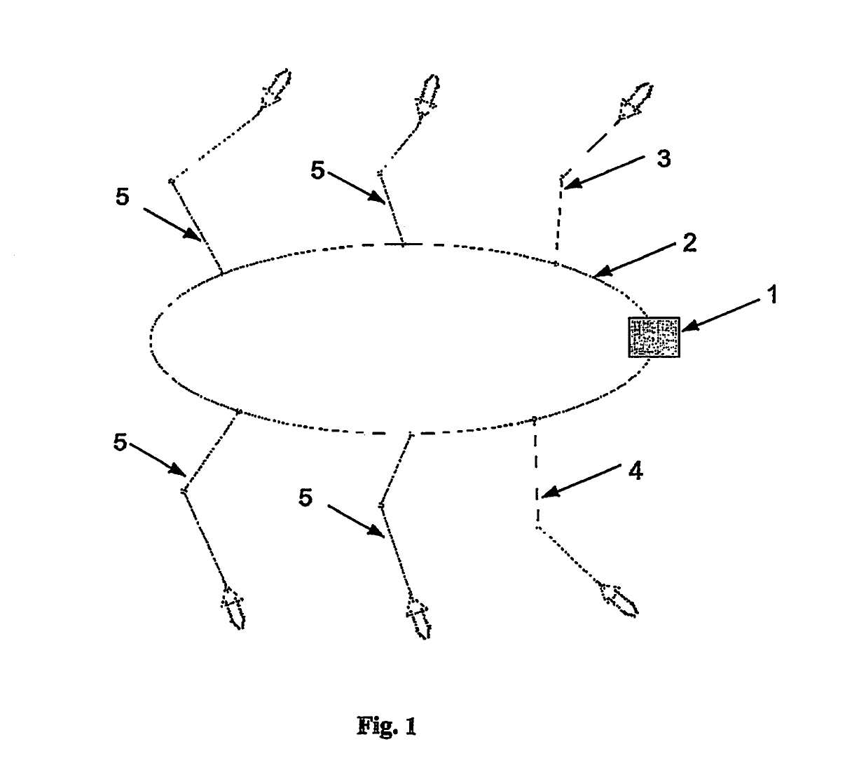

FIG. 1—shows the bunch of the gripper and schematic diagram of the robot (manipulator with a gripper system) operation;

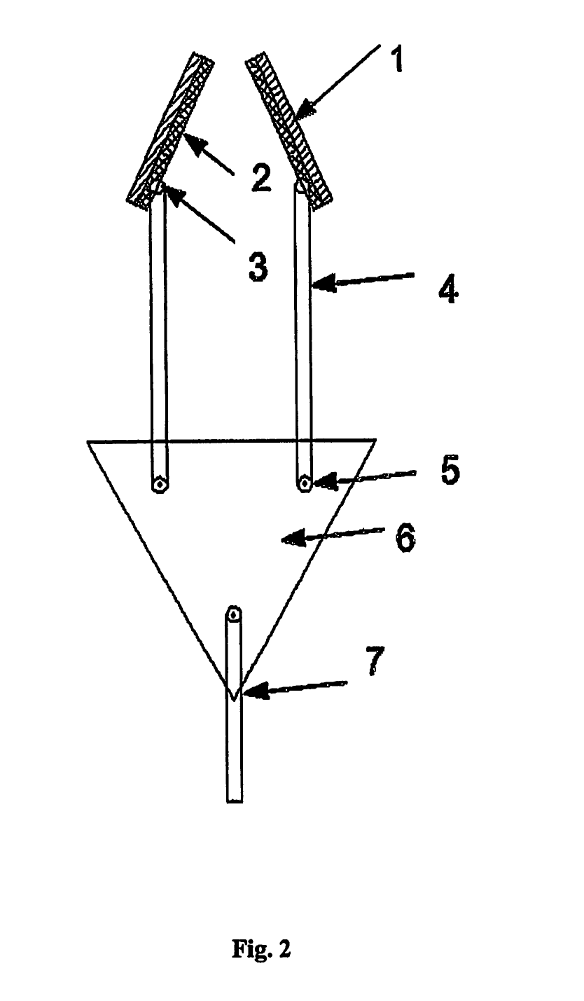

FIG. 2 shows the range of movement of the gripper;

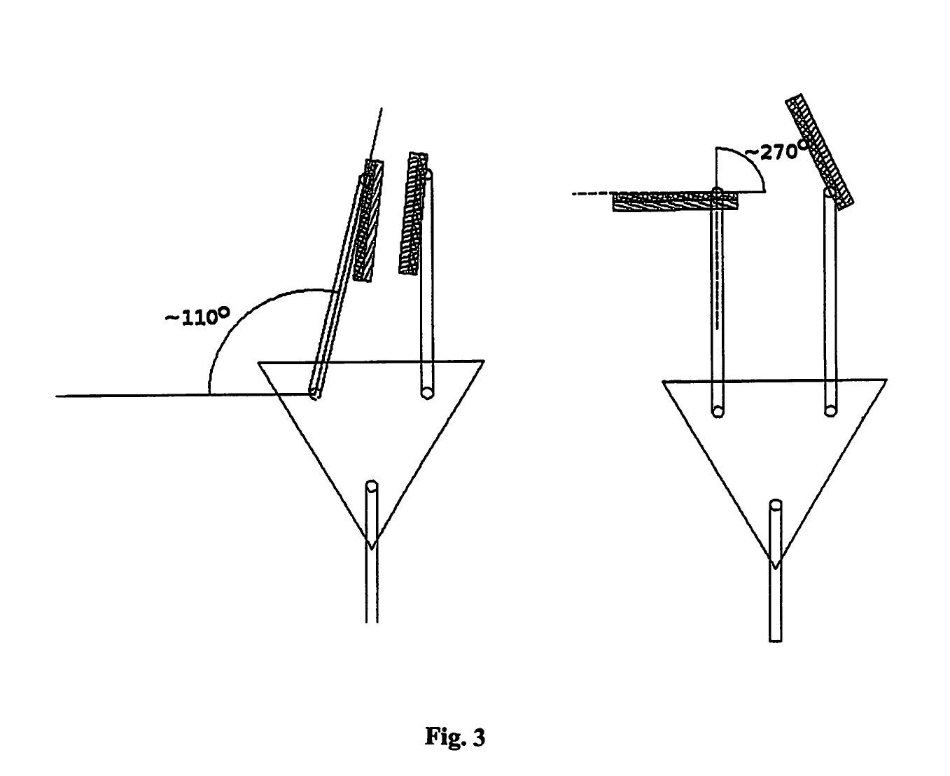

FIG. 3 shows the range of movement of the manipulator and

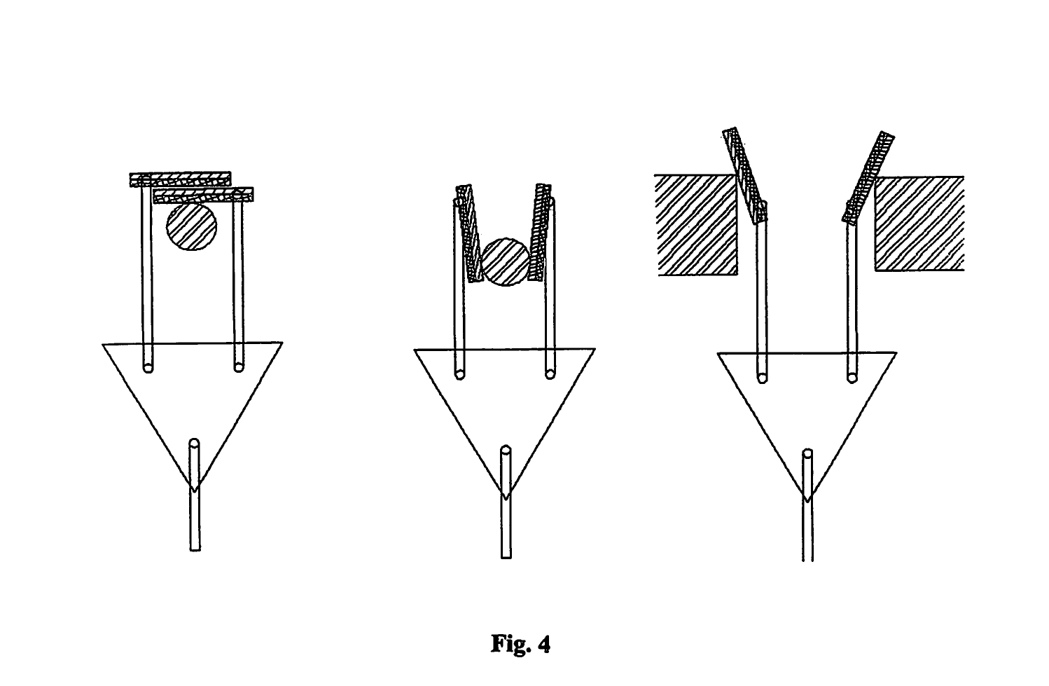

FIG. 4 shows way of grasping by a robot.

The inspection robot according to the invention has a gripper 4 fitted with the gripper tip 1,2 consisting of two layers, wherein the layer 1 is made of an elastic material having a high coefficient of friction, it may be a soft rubber or latex, and the layer 2 is made of a hard material having a low coefficient of friction, e.g. metal or metal coated with Teflon; the tip of the gripper has an axis of rotation 3 and the wrist housing 6 has a hinge 5 on which the gripper 4 is mounted. The arm 7 connects the bunch with the robot body.

The body of the robot has not less than 6 moving legs. The robot is controlled remotely via radio waves so that the operator has a view from a camera mounted on the robot body and controls the front legs. Rear legs move autonomously repeating the movement of the front legs. Robot builds the image of the surrounding space in the memory and stores the distance traveled, thus it can move back in case of loss of connection with the operator. The arm performs rotations of the same distance from each other in the range 110° and 270°. The gripper arms 4 have the axis of rotation 3 of the gripper tip which gives the ability to maneuver. This robot can grip by suspending on the horizontal rod (8) and gripping the rod with a cladding with a high coefficient of friction. You can hook up e.g. spool of wire/fishing line to the robot and thus drag the pilot introducing the installation between distant points over the ceiling.

1. Robot for over-ceiling space inspection fitted with the enclosure with a camera inside with the preview on the operator's computer display characterized in that it has the gripper (4) with the axis of rotation (3) of the gripper tip (1,2) and the wrist body (6) which has the gripper hinge (5) and the arm (7) connecting the bunch with the robot body.

2. Robot of claim 1, characterized in that it has not less than 6 walking legs (10), where the hind legs move autonomously repeating the movement of the front legs (10).

3. Robot of claim 1, characterized in that the components of the gripper (4) have a defined range of operation (9), the gripper in the wrist—110° and the gripper tip—270°.

4. Robot of claim 1, characterized in that it has the gripper tip composed of two layers (1,2), wherein the layer (1) is made of an elastic material having a high coefficient of friction, while the layer (2) is made of a hard material having a low coefficient of friction.
